(19) United States
(12) Patent Application Publication
(10) Pub. No.: US 2025/0330447 A1
(43) Pub. Date: Oct. 23, 2025

(54) SYSTEM AND METHOD FOR APPLICATION-BASED MICRO-SEGMENTATION

(71) Applicant: Aviatrix Systems, Inc., Santa Clara, CA (US)

(72) Inventors: Geetha Anandakrishnan, Santa Clara, CA (US); Susan Hinrichs, Santa Clara, CA (US); Daniel Xu, Santa Clara, CA (US); Narayanan Meiyyappan, Santa Clara, CA (US); Mandar Jog, Santa Clara, CA (US)

(73) Assignee: Aviatrix Systems, Inc., Santa Clara, CA (US)

(21) Appl. No.: 18/861,872

(22) PCT Filed: Apr. 30, 2023
(86) PCT No.: PCT/US2023/020513

§ 371 Date: Oct. 30, 2024

Related U.S. Application Data
(60) Provisional application No. 63/337,055, filed on Apr. 30, 2022.

(51) Int. Cl. H04L 9/40

(52) U.S. Cl. CPC H04L 63/0272; H04L 63/0263

(57) ABSTRACT

A system and method for controlling the handling of intra-VPC and inter-VPC communications is described. First, a destination of a communication is determined it resides within a first virtual private cloud network (VPC) of a source of the communication. If so, filtering communications between the destination and the source is controlled by native cloud constructs associated with a cloud service provider (CSP) underlay network for the first public cloud network. Otherwise, filtering communication between the destination and the source is controlled by a spoke gateway. The spoke gateway is part of a cloud overlay network configured to provide a communication path between the first virtual private cloud network and the second private cloud network and using micro-segmentation to set and manage security policies.

### CROSS-REFERENCE(S) TO RELATED APPLICATION

This patent application claims priority from, and incorporates by reference the entire disclosure of, U.S. Provisional Patent Application No. 63/337,055 filed on Apr. 30, 2022.

### TECHNICAL FIELD

Embodiments of the disclosure relate to the field of networking. More specifically, one embodiment of the disclosure relates to a network traffic routing control system that conducts micro-segmentation through the establishment of application domains within a single cloud and multi-cloud network deployment.

### GENERAL BACKGROUND

Over the past few years, cloud computing has provided Infrastructure as a Service (IaaS), where components have been developed to leverage and control the native constructs for all types of public cloud networks, such as AMAZON® WEB SERVICES (AWS), MICROSOFT® AZURE® Cloud Services, GOOGLE® Cloud Services, or the like. These components operate as part of a cloud network infrastructure, which overlays portions of a public cloud network or multiple public cloud networks and provides enhanced functionality (e.g., enhanced security, increased visibility, etc.).

The overlaying network infrastructure may be configured to support hundreds of tenants (e.g., different persons, organizations or other entities) concurrently by implementing virtual networking infrastructures, where the construct of these virtual networking infrastructures may vary depending on the public cloud provider. For example, the virtual networking infrastructures may include virtual private clouds for AMAZON® WEB SERVICES (AWS), virtual networks (Vnets) for MICROSOFT® AZURE® Cloud Services, or the like. For ease and consistency, we shall refer to all types of these virtual networking infrastructures as a “virtual private cloud network” or “VPC.”

In general, a “VPC” is an on-demand, configurable pool of shared resources, which may be allocated within the overlaying network infrastructure and provides a certain level of isolation between the different tenants using the cloud resources. Overlaying the infrastructure of a public cloud network, certain types of VPCs, referred to as “spoke” VPCs, may be used as an entry point in the routing of messages, received from resources within an on-premises network or resources within the spoke VPC itself, between components forming a portion of the overlaying network infrastructure. These VPCs may be configured to support the routing of messages with the same region of a public cloud network, different regions of the same public cloud network, or different public cloud networks.

For security, network administrators can rely on micro-segmentation, namely a security method of managing network access between resources configured to run an application instance. Micro-segmentation allows network administrators to set and manage security policies that control propagation of network data traffic in an effort to reduce exposure of the resources to cybersecurity attacks as well as strengthen security compliance throughout the network. Micro-segmentation may be utilized without the need of re-designing the network architecture.

From a security perspective, micro-segmentation enables network administrators to allow and/or deny communications between specific resources. However, the management of networks relying on micro-segmentation as a security feature has been challenging. To support micro-segmentation with current network infrastructures, the network administrators would have the daunting task of tag management, where the tags may be directed to different types of resources and reliance on tags for policies poses reliability and scaling issues.

### SUMMARY OF THE INVENTION

An embodiment of the claimed invention is directed to a controller comprising a processor; and a non-transitory storage medium communicatively coupled to the processor, the non-transitory storage medium includes (i) classification logic that, based on recovered information associated with a newly discovered endpoint, determines a virtual region in which the newly discovered endpoint resides, and (ii) rule generation logic.

A further embodiment of the claimed invention is directed to a method for controlling network traffic flow separation between inter-VPC communications and intra-VPC communications.

Another embodiment of the claimed invention is directed to a non-transitory storage medium including logic that, upon execution, controls flow separation for inter-VPC communications and intra-VPC communications.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1A is a first exemplary embodiment of a cloud platform deploying a network traffic routing control system.

FIG. 1B is a second exemplary embodiment of the cloud platform illustrating connectivity to an on-premises network.

FIG. 2 is an exemplary embodiment of a logical architecture of the controller of FIG. 1 featuring management logic, security logic and policy configuration logic that collectively support micro-segmentation.

FIG. 3A is an exemplary embodiment of a first display screen rendered by a graphic user interface (GUI) of the virtual appliance of FIGS. 1A-1B to control operability of the multi-cloud network through a micro-segmentation scheme.

FIG. 3B is an exemplary embodiment of a second screen display rendered in response to selection of a security display element 330 of FIG. 3A for configuring micro-segmentation of the multi-cloud network of FIGS. 1A-1B.

FIG. 4A is an exemplary embodiment of a third display screen rendered in response to selection of the Micro-Segmentation display element illustrated in the second screen display of FIG. 3B.

FIGS. 4B-4C are exemplary embodiments of an interactive display area generated and displayed for creation of an application domain with resource based on tag selection.

FIG. 4D is an exemplary embodiment of the interactive display area generated and displayed for creation of the application domain with resource based on Internet Protocol (IP) address selection.

FIG. 5A is an exemplary embodiment of an exemplary embodiment of a fourth display screen for routing rule generation.

FIG. 5B is an exemplary embodiment of the fourth display screen illustrating a routing rule configured in accordance with the operations illustrated and described in FIG. 5A.

FIG. 6A is an exemplary embodiment of a first interactive display area generated and displayed to illustrate resources of a first application domain created upon conducting a set of operations illustrated in FIGS. 4A-4D.

FIG. 6B is an exemplary embodiment of a second interactive display area generated and displayed to illustrate resources of a second application domain created upon conducting the set of operations illustrated in FIGS. 4A-4D.

FIG. 6C is an exemplary embodiment of a third interactive display area to illustrate a routing rule controlling operability of the first and second application domains of FIGS. 6A-6B, where the routing rule is configured in accordance with the operations illustrated in FIGS. 5A-5B

FIG. 7 is an exemplary embodiment of the application domain.

### DETAILED DESCRIPTION

Embodiments of a network traffic routing control system are described. The network traffic routing control system includes routing control logic operating with cloud components of a software-defined network constructed to overlay one or more public cloud networks (hereinafter, “cloud platform”). Collectively, the routing control logic and the cloud components are configured to support micro-segmentation over a single public cloud network or multiple (different) public cloud networks. The routing control logic may be deployed within a centralized controller, with a subset of these cloud components being responsible for controlling egress and ingress communications over the cloud platform between resources associated with different VPCs. A “resource” may include, but is not limited or restricted to a virtual private cloud network (VPC), a virtual subnetwork, a virtual machine (VM) instance, or another type of computing device configured to run an application instance. Communications between resources within the same VPC are controlled by native constructs within a public cloud network, which do not pertain to operability of the routing control logic as claimed.

As described herein, the routing control logic is configured to collect and/or distribute attributes associated with one or more resources with a single public cloud network or a multiple public cloud network (hereinafter, multi-cloud network”). The collection and/or distribution may be triggered by an event, where the event may be periodic or aperiodic. For example, the event may be aperiodic such as a query message from a virtual appliance as described below. Alternatively, the event may be periodic such as a scheduled (time/date) inventory of resources that are associated with a tenant and reside within a public cloud network or a multi-cloud network. For clarity, operations of the network traffic routing control system, especially micro-segmentation, will be described in connection with resources deployed within a multi-cloud network.

Besides connection and/or distribution of resource attributes, the routing control logic may be configured to operate with a virtual appliance to create one or more application domains along with programmable routing policies that control communications between different application domains. An application domain isolates resources, including resources residing within different VPCs operating within the different public cloud networks (e.g., resources within the multi-cloud network), where routing policies may be configured to control transmissions to/from any of these resources included within the application domain.

Herein, the application domains may be created by selection of resources based on their assigned tags, and the routing policies may be created by imposing actions (e.g., allow, deny, re-route) on communications between resources represented by these assigned tags. However, the routing control logic may be configured to modify, store and download, to selected cloud components of the cloud platform, filter and/or routing rules pertaining to the routing policies (hereinafter, “routing rules”). The modification involves a conversion of user-defined tags associated with each resource governed by a routing rule (e.g. resources identified as the “source” application domain or the “destination” application domain. The selected cloud components may include spoke gateways and/or transit gateways, which are computing devices responsible for enforcing data plane operability in accordance with the routing rules.

More specifically, spoke gateways and/or transit gateways forming the cloud platform may locally store rules associated with the routing policies for application domains involving one or more resources (e.g., VM instances, virtual subnetworks, VPCs) to which these gateways control egress and ingress communications. For example, the routing policies for application domains feature routing rules that are directed to controlling transmissions from/to resources operating as a source/destination. According to one embodiment of the disclosure, these routing policies are created based on tags associated with resources selected to be part of the application domains, but subsequently, the routing control logic is responsible for converting routing policies developed using a user interface of the virtual appliance to rely on Internet Protocol (IP) addressing for each resource in lieu of its tag. Stated differently, the routing control logic is configured to convert portions of routing rules associated with each routing policy by substituting the tag identifying a resource pertaining to a source or destination application domain with an IP address associated with that resource. The IP addresses of the resources are obtained, along with their tags, during an inventory of resources conducted by the controller.

For example, an application domain may include a plurality of resources, where each resource within the application domain is associated with a tag used to populate the application domain. As an illustrative example, a resource may be assigned one or more tags, where one tag may constitute a first key value pair (e.g., Name:VM-A) while another tag may constitute a key value pair (e.g., Department:Sales), where an VM instance (VM-A) may be part of a sales department recognized as a category (selector) for a first public cloud network (AWS) while other VM instances (VM-B, VM-C) may be part of a sales department recognized as a category for a second public cloud network (Azure). During processing and prior to passing the routing rule to a cloud component, the routing control logic converts tag “Name: VM-A” to the IP address associated with the VM-A instance (e.g., 192.168.10.1) and tag (Department:Sales) to the IP addresses associated with VM-B & VM-C instances (e.g., 192.168.50.30 & 192.168.50.40).

Alternatively, in lieu of the key value pair, the application domain configuration allows for entry of an IP address range (e.g., subnet address, a Classless Inter-Domain Routing (CIDR) address), where the application domain would include all cloud components assigned IP addresses within that IP address range. Hence, no tag-to-IP address conversion is necessary if tags are not used in generation of the application domain.

Herein, implementing the routing control logic, the controller may be communicatively coupled to the virtual appliance that operates in tandem with the controller to provide an organized, global operational view of a tenant's multi-cloud network along with dynamic topology mapping to maintain an accurate topology of their global multi-cloud networks, analyze global network traffic flows to easily pinpoint and troubleshoot traffic anomalies. The virtual appliance leverages attribute information collected by the controller to formulate micro-segmentation of the tenant's multi-cloud network in allowing, denying or re-routing network communications (e.g., messages) over the network.

### I. Terminology

In the following description, certain terminology is used to describe features of the invention. In certain situations, each of the terms “logic” and “component” is representative of hardware, software, or a combination thereof, which is configured to perform one or more functions. As hardware, the logic (or component) may include circuitry having data processing and/or storage functionality. Examples of such circuitry may include, but are not limited or restricted to a processor (e.g., microprocessor, one or more processor cores, a programmable gate array, a microcontroller, an application specific integrated circuit, etc.); non-transitory storage medium; combinatorial circuit elements that collectively perform a specific function or functions, or the like.

Alternatively, or in combination with the hardware circuitry described above, the logic (or component) may be software in the form of one or more software modules. The software module(s) may be configured to operate as one or more software instances with selected functionality (e.g., virtual processor, data analytics, etc.) or as a virtual network device including one or more virtual hardware components. The software module(s) may include, but are not limited or restricted to an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device.

One type of component may be a cloud component, namely a component that operates within a cloud-based network. Cloud components may be part of a network overlay operating to control message routing between native code components of one or more public cloud networks. The cloud components associated with the native code may be referred to as “native cloud components.”

Controller: A “controller” is generally defined as a component that manages operability of cloud components within a one or more regions of a single public cloud network or within multiple (two or more) public cloud networks (hereinafter, “multi-cloud network”). This management may include leveraging intelligence (e.g., addresses, attributes such as assigned tags, etc.) acquired from cloud components communicatively coupled to the gateways forming a portion of an overlay network whose operability is controlled by the controller. According to one embodiment, the controller may include management logic, security logic and policy configuration logic to install policies directed to routing rules, which may be unique to each gateway and/or each VPC based on active application domains. The routing rules may be applied by the gateways to control egress or ingress transmissions from an application instance deployed within the VPC.

Tenant: Each “tenant” uniquely corresponds to a particular customer provided access to the cloud or multi-cloud network, such as a company, individual, partnership, or any group of entities (e.g., individual(s) and/or business(es)).

Computing device: A “computing device” is generally defined as virtual or physical logic with data processing and/or data storage functionality. Herein, a computing device may include a virtual device that is configured to perform functions based on information received from cloud components. For example, the computing device may correspond to a virtual server configured to execute software instances. The computing device may correspond to a virtual routing device that is responsible for controlling communications between different resources, such as a gateway for example.

Gateway: A “gateway” is generally defined as virtual or physical logic with data monitoring or data routing functionality. As an illustrative example, a first type of gateway may correspond to virtual logic, such as a data routing software component that is assigned an Internet Protocol (IP) address within an IP address range associated with a virtual networking infrastructure (VPC) including the gateway, to handle the routing of messages within and from the VPC. Herein, the first type of gateway may be identified differently based on its location/operability within a public cloud network, albeit the logical architecture is similar.

For example, a “spoke” gateway is a gateway that supports routing of network traffic between a component requesting a cloud-based service and a VPC that maintains the cloud-based service available to multiple (two or more) tenants. A “transit” gateway is a gateway configured to further assist in the propagation of network traffic (e.g., one or more messages) between different VPCs such as different spoke gateways within different spoke VPCs. Alternatively, in some embodiments, the gateway may correspond to physical logic, such as a type of computing device that supports and is addressable (e.g., assigned a network address such as an IP address).

Virtual Appliance: A “virtual appliance” is generally defined as software operating in conjunction with the controller to render display screens that allows a tenant to visualize and control operability of a single (public) cloud network or multi-cloud network.

Transmission Medium: A “transmission medium” is generally defined as a physical or logical communication link (or path) between two or more components. For instance, as a physical communication path, wired and/or wireless interconnects in the form of electrical wiring, optical fiber, cable, bus trace, or a wireless channel using infrared, radio frequency (RF), may be used. As a logical communication link, an API, a function call, or the like may be used to communicatively couple two or more components together.

Computerized: This term generally represents that any corresponding operations are conducted by hardware in combination with software.

Message: Information in a prescribed format and transmitted in accordance with a suitable delivery protocol. Hence, each message may be in the form of one or more packets (e.g., data plane packets, control plane packets, etc.), frames, or any other series of bits having the prescribed format.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### II. Network Traffic Routing Control System Architecture/Operability

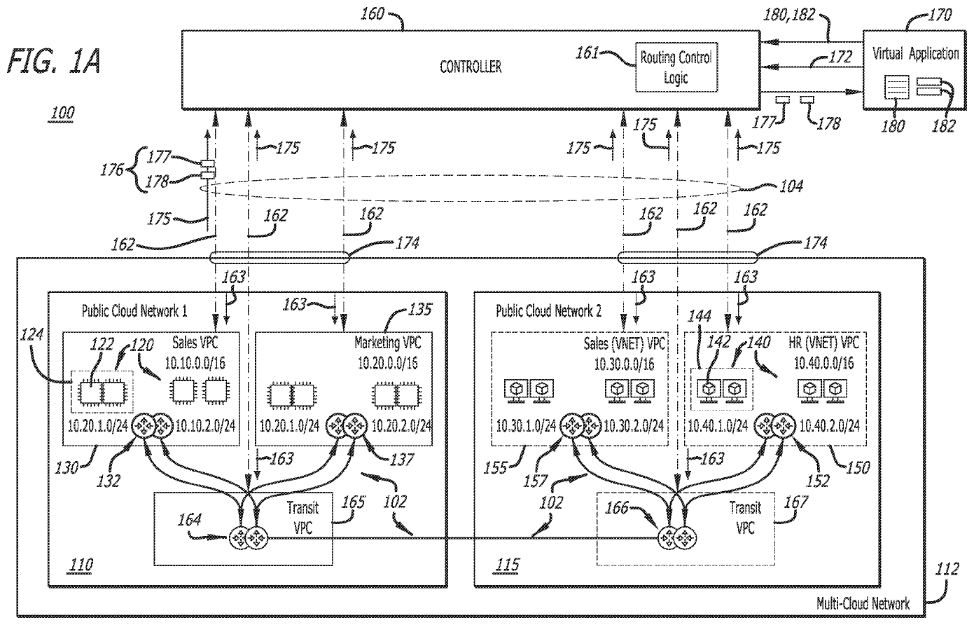

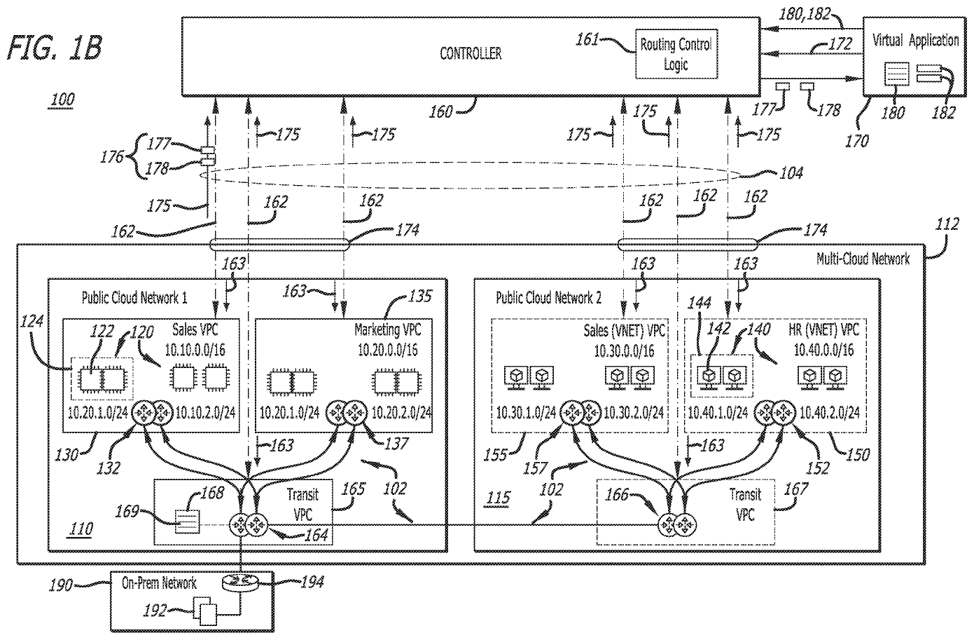

Referring now to FIG. 1A, a first exemplary embodiment of a cloud platform 100 deploying a network traffic routing control system 105 is shown. As described below, the network traffic routing control system 105 features a controller 160 with routing control logic 161 that is responsible for modifying one or more routing rules 182 (hereinafter, “routing rule(s)”) associated with one or more application domains 180 (hereinafter, “application domain(s)”) before distribution to cloud components, such as spoke gateways 132, 137, 152, and/or 157 that control egress and/or ingress communications with resources included in the application domain(s) 180.

As shown in FIG. 1A, the cloud platform 100 may correspond to a software-defined cloud or multi-cloud overlay network featuring cloud components in communication through messages using private network addresses such as Internet Protocol (IP) addresses. As shown, the cloud platform 100 operates as an overlay network that supports and controls the routing of communications between resources within a multi-cloud network 112, namely resources within a first public cloud network 110 and resources within a second public cloud network 115.

According to one illustrative embodiment, the cloud platform 100 is configured to provide connectivity between resources 120 associated with a first virtual private cloud network (VPC) 130 (e.g., sales VPC) and resources 140 associated with a second VPC 150 (e.g., Human Resources “HR” VNet). The resources 120 may include one or more virtual machine (VM) instances 122, one or more virtual subnetworks (subnets) 124, and/or the first VPC 130 itself. Similarly, the resources 140 may include one or more virtual machine (VM) instances 142, one or more subnets 144, and/or the second VPC 150 itself.

Herein, the cloud platform 100 operating as an overlay network includes a data plane 102 and a control plane 104. The control plane 104 refers to all functions and/or processes that determine which routing path to use when sending a control message between cloud components. The data plane 102 refers to all functions and/or processes that forward data messages from one interface to another based on controls set by a controller 160 communicatively coupled to the control plane 104.

For example, according to one embodiment of the disclosure, the data plane 102 may be configured with cloud components that enable the transfer of data messages over the cloud platform 100. For instance, as an illustrative embodiment, the data plane 102 may include spoke gateways 132 associated with the first VPC 130, spoke gateways 152 associated with the second VPC 150, transit gateways 164 associated with a first transit VPC 165 and transit gateways 166 associated with a second transit VPC 167. The transit gateways 164/166 provide connectivity between different VPCs. The different VPCs may reside within the same public cloud network (e.g., VPCs 130 and 135 within the first public cloud network 110, VPCs 150 and 155 within the second public cloud network 115, etc.). Additionally, or in the alternative, these different VPCs may reside within different public cloud networks (e.g., VPCs 130 and 150) as shown.

Similarly, the control plane 104 features transmission mediums 162 communicatively coupling the controller 160 to other components of the cloud platform 100, such as the spoke gateways 132, 137, 152 and 157 and/or the transit gateways 164 and 166 as shown. The control plane 104 is relied upon for the controller 160 to issue resource discovery messages 163 to the spoke gateways 132/137/152/157 (and optionally transit gateways 164 and 166), where the resource discovery messages initiate a resource discovery process conducted by native cloud components of the CSP, which returns information (e.g., tag(s), network address, and other attributes) associated with resources within VPCs 130/135/150/155 (and optionally transit VPCs 165 and 167) via a discovery response message 175. To reduce bandwidth usage, the returned information may pertain to newly discovered resources and/or resources that have been modified (updated) since the prior resource discovery process.

Referring still to FIG. 1A, a virtual appliance 170 (e.g., software with a user interface for collection, organization and display of network attributes associated with resources within the multi-cloud network 112) is configured to receive at least portions of the returned information (e.g. tags) included within the discovery response message 175 to generate one or more application domains 180. Besides application domain(s) 180, one or more routing rules 182 may be configured for the application domain(s) 180. During or after configuration, the routing rule(s) 182 is provided to the routing control logic 161, which performs tag-to-IP address conversion on tags associated with resources identified in the application domain(s) 180 and pertaining to the routing rule(s) 182. The tag-to-IP address conversion is conducted prior to distribution of the routing rule(s) 182 to local data stores accessible by at least the spoke gateways 132/137/152/157. The routing rule(s) 182 influence operability of the spoke gateways such as spoke gateways 132 and/or 152 (when the application domain(s) 180 includes resources within the first and second VPCs 130 and 150) by controlling (e.g., filtering or re-routing) certain communications between the first VPC 130 and second VPC 150. Additionally, or in the alternative, the routing rule(s) 182 may be distributed to local data stores accessible by at least the transit gateways 164/166 to control operability of certain communications between the first VPC 130 and second VPC 150.

As an illustrative example, responsive to a tag query message 172 from the virtual appliance 170 (e.g., Aviatrix® CoPilot™ software), the controller 160 is configured to utilize one or more APIs 174, provided by a cloud service provider (CSP) for each of the public cloud networks 110 and/or 115, to collect network information associated with tenant's resources within VPCs deployed in the public cloud network(s) 110 and/or 115. The API(s) 174 allow for the controller 160 to gather network information 176, inclusive of network (IP) address 177 and attributes 178 (e.g., tags assigned through operations with native cloud components) associated with resources within the VPCs. The network information 176 is provided as part of the discovery response message 175 to the controller 160. As shown, the controller 160 is configured to collect the network information 176 associated with cloud components, such as VM instance(s) 122, virtual subnetwork 124, and/or the VPC 130, via API 174 and/or transmission medium(s) 162.

Herein, the virtual appliance 170 operates in tandem with the controller 160 to provide an organized, global operational view of a tenant's multi-cloud network 112 along with dynamic topology mapping to maintain an accurate topology of their global multi-cloud networks, analyze global network traffic flows to easily pinpoint and troubleshoot traffic anomalies. The virtual appliance 170 leverages the attributes 178 collected by the controller 160, such as tags for example, in the creation of application domain(s) 180 that effectuate micro-segmentation of the tenant's multi-cloud network 112 in allowing, denying or re-routing certain network communications (e.g., messages) propagating over the multi-cloud network 112.

Referring now to FIG. 1B, a second exemplary embodiment of the cloud platform 100 illustrating connectivity to an on-premises (on-prem) network 190 is shown. As described above, the cloud platform 100 includes the data plane 102 and the control plane 104. The control plane 104 features transmission mediums 162 communicatively coupling the controller 160 as well as transit gateways 164. Herein, the transit gateway(s) 164 includes a data store 168 configured to store routing rules 169 for the application domains to control egress and ingress transmissions between the on-prem network 190 and resources within any of the VPCs, such as a virtual machine (VM) instance 122 or a virtual subnetwork (subnet) 124 within the first VPC 130 for example.

As described in FIG. 1A, the routing control logic 161 is configured to perform tag-to-IP address conversion on the routing rule(s) 182 prior to storage within local data store(s) (e.g., local data store 168) relied upon by at least the transit gateways 164. The routing rule(s) 182 pertaining to resources associated with application domain(s) set by the tenant, where the application domain(s) 180 includes resources 192 within the on-prem network 190 and an edge routing device 194 for the on-prem network 190 is not operating as an extension of the cloud platform 100. The routing rule(s) 182 may include rules that cause the transit gateway 164 to control (e.g., filter or re-route) the receipt (ingress) of data messages to and/or transmission (egress) of data messages from the on-prem resources 192.

### III. Controller-Network Traffic Routing Control System

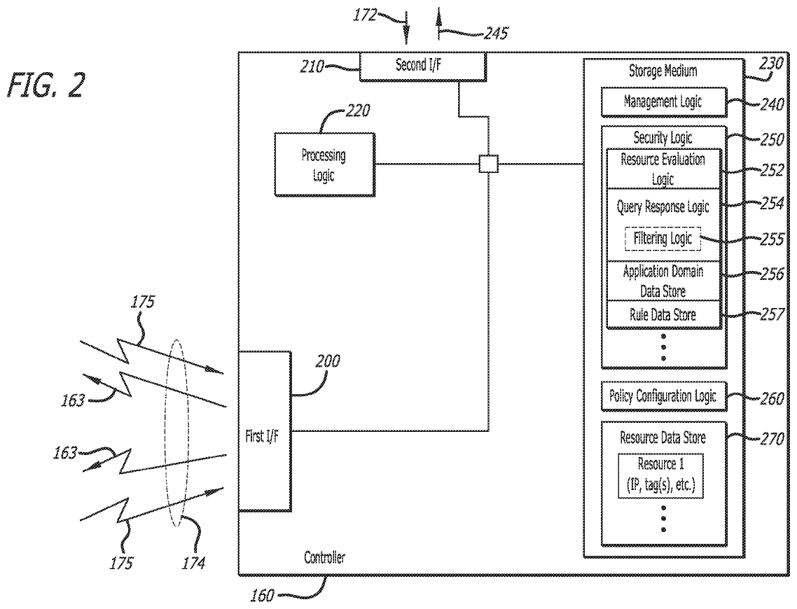

Referring now to FIG. 2, an exemplary embodiment of a logical architecture of the controller 160 of FIGS. 1A-1B featuring management logic 240, security logic 250 and policy configuration logic 260 is shown. Herein, the controller 160 includes one or more interfaces, which are illustrated as a first interface 200 and a second interface 210. The first interface 200 provides for connectivity between cloud components associated with the cloud platform 100 while the second interface 210 provides for connectivity with the virtual appliance 170 of FIGS. 1A-1B. Besides the interfaces 200 and 210, the controller 160 further includes processing logic 220 and a non-transitory storage medium 230. The non-transitory storage medium 230 includes the management logic 240, the security logic 250, and the policy configuration logic 260.

Herein, according to one embodiment of the disclosure, the management logic 240 is configured to support communications with cloud components being part of the resources 120/140 of the cloud platform 100. For instance, in response to the controller 160 receiving the tag query message 172 from the virtual appliance 170, the management logic 240 is configured to initiate resource discovery messages 163 through one or more CSP-provided APIs 174 to communicate with native cloud components of the CSPs. The CSP's native cloud components (not shown) are adapted to return one or more discovery response messages 175, where each discovery response message 175 includes network information 176 (e.g., network (IP) address(es) 177, tags(s) 178, and/or other attributes) pertaining to resources in communication with the gateway(s). For example, as shown in FIG. 1A and FIG. 2, the spoke gateway 132 is adapted to return the discovery response message 175, which includes IP addresses and network attributes associated with resources within the first VPC 130, including VM instances associated with the first virtual subnet 124 (CIDR 10.20.1.0/24) and VM instances associated with a second virtual subnet (CIDR 10.20.2.0/24).

Besides controlling the discovery message exchange described above, the management logic 240 is further configured to parse content of the received discovery response message(s) 175 to obtain and identify the IP address associated with each resource along with their corresponding attributes (e.g., one or more tags assigned to that cloud component). The IP address along with its corresponding network attributes are stored within a resource data store 270.

As shown in FIG. 2, the security logic 250 is configured to support communications with the virtual appliance 170 for generating application domains and/or routing policies associated with these application domains. Herein, the security logic 250 includes resource evaluation logic 252, which is configured to conduct analytics on network information included as part of the received discovery response message 175. The analytics may include identification and organization of the network information, which would include the network (IP) address and attributes (e.g., tags, etc.) associated with each discovered resource. The network information may be stored within the resource data store 270.

Additionally, prior to storage of the network information within the resource data store, the resource evaluation logic 252 may further conduct analytics on the network information to detect resource(s) have been newly discovered and/or resources have been updated since the last discovery message exchange. These analytics may involve a comparison between IP addresses associated with the discovered resources and IP addresses associated with already known resources. For newly discovered resources (i.e. resource IP addresses are not currently maintained within the resource data store 270), the network information associated with the resource (e.g., IP address, tags, etc.) is stored within the resource data store 270. However, for IP address associated with discovered resources already included in the resource data store 270, an analysis of the attributes of each discovered resource may be conducted to confirm that no attribute changes have been made. For example, this may be accomplished by conducting a hash operation on the attributes of the discovered resource and comparing with a running, stored hash value of the attributes associated with the known (and stored) resource within the resource data store 270. Any differences would denote a change in the attributes and warrant an update of the attributes into the resource data store 270.

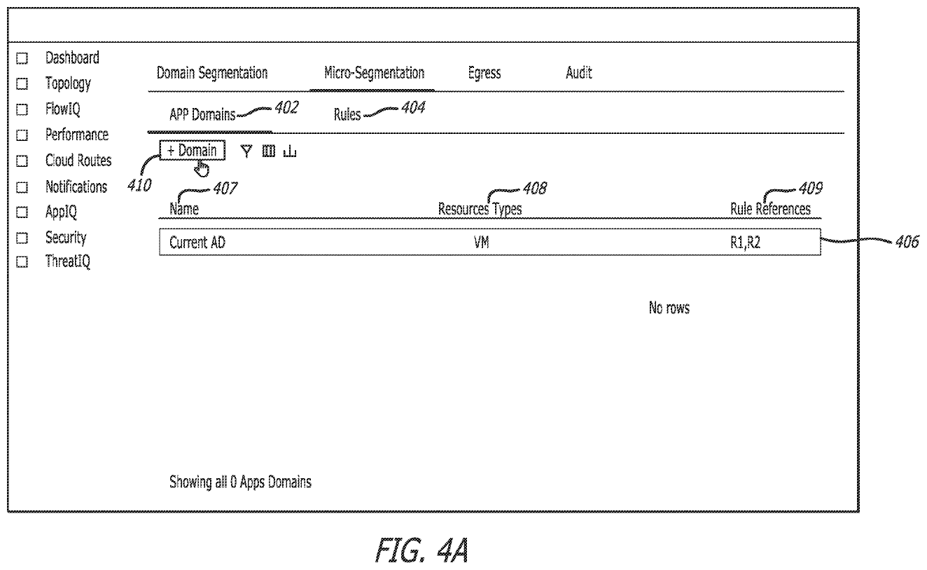

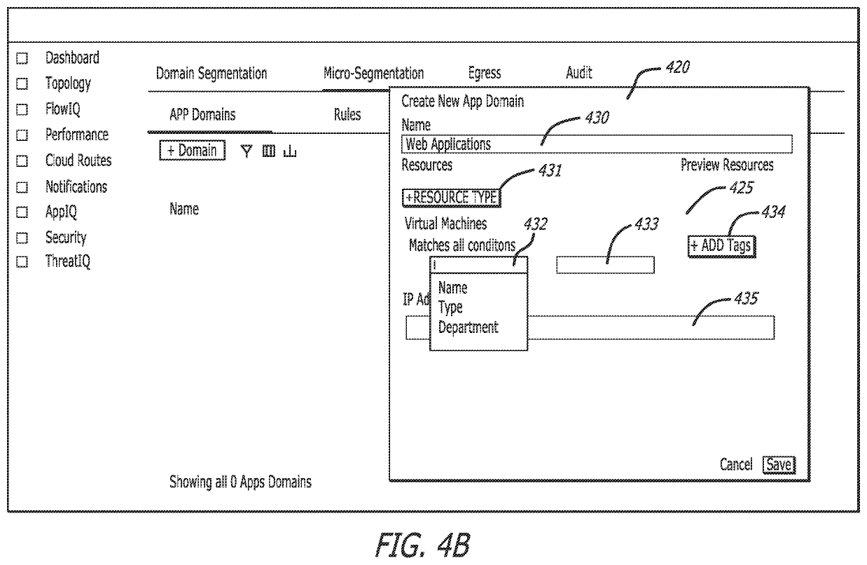

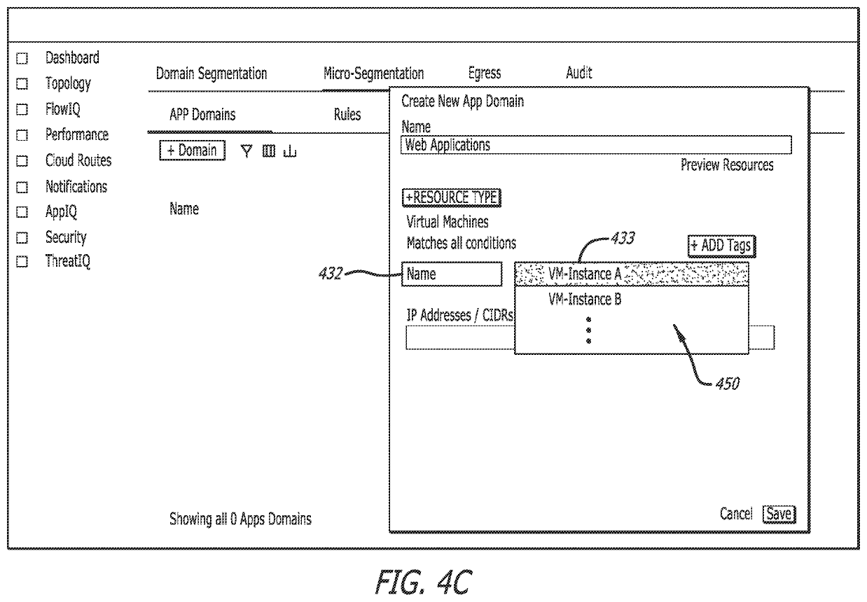

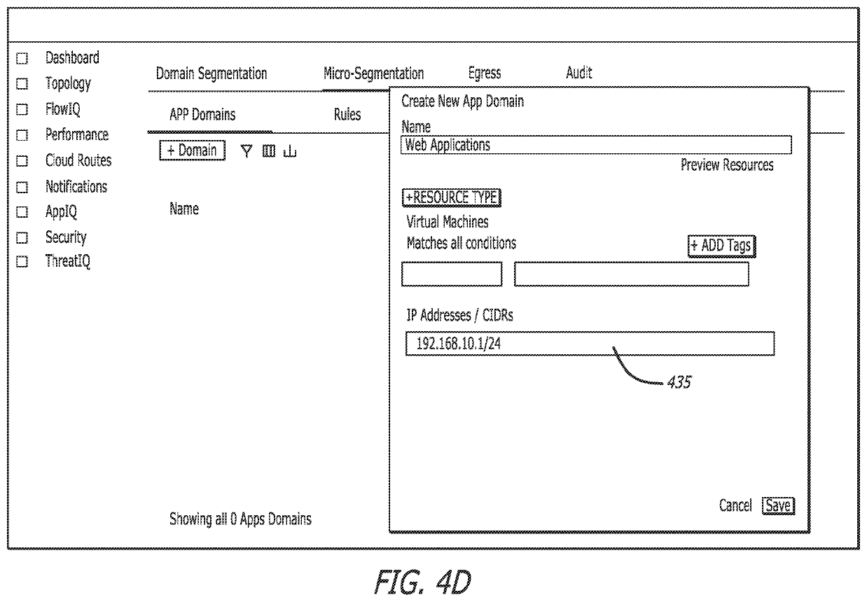

Herein, according to one embodiment of the disclosure, the network information associated with the discovered resource(s) maintained within the resource data store 270 may be accessible by the virtual appliance 170 in generation of the application domains. In particular, the resource data store 270 may be organized to enable the virtual appliance 170 to access key pair values (tags) associated with the discovered resources of the multi-cloud network 112 of FIGS. 1A-1B. According to another embodiment of the disclosure, the security logic 250 may include query response logic 254, which is responsible for generating a tag reply message 245, in response to the tag query message 172, in order to provide tag information pertaining to resources within the multi-cloud network 112. The tag information may be utilized by logic within the virtual appliance 170 in generating an application domain as illustrated in FIGS. 4A-4D. The content associated with the resultant application domain may be stored within an application domain data store 256.

It is contemplated that the query response logic 254 may be configured with filtering logic 255 to optimize bandwidth usage between the controller 160 and the virtual appliance 170. For example, the filtering logic 255 may be configured, in response to receipt of discovery response message(s) 175 prompted by corresponding resource discovery message(s) 163, to return the network information 176 that pertains only to resources that have been updated or newly added to the multi-cloud network 112. Alternatively, the filtering logic 255 may be configured to control the return network information 176 associated with newly discovered resources, but only return updated attributes of known (discovered) resources.

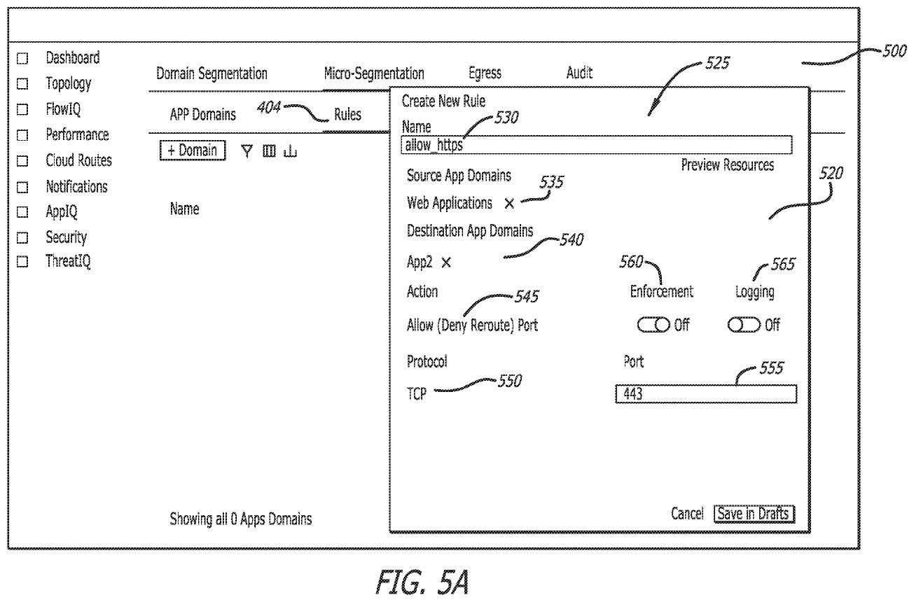

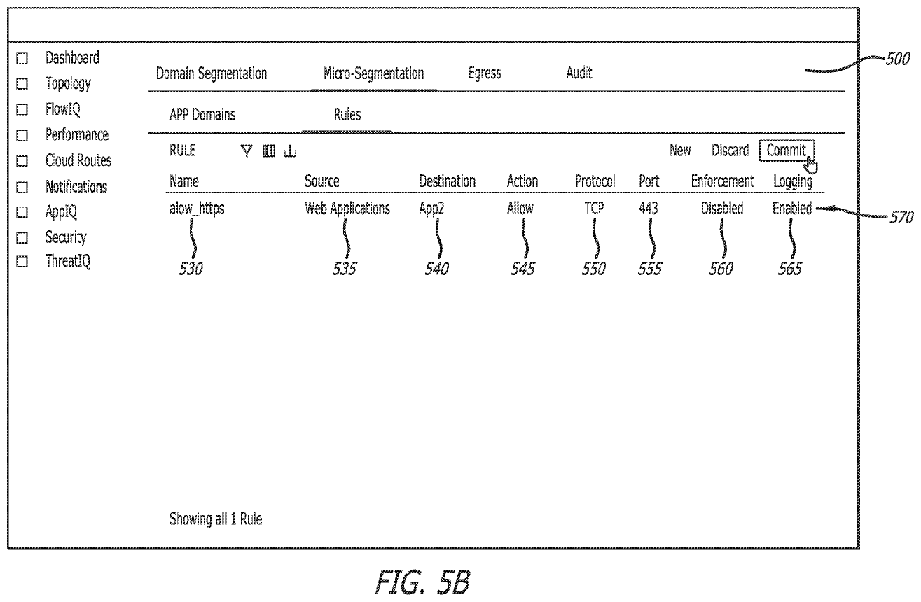

After configuration of application domains, routing policies may be created for these application domains. As described below, each routing policy may feature one or more routing rules that are generated based on selection of display elements represented on a graphic user interface (GUI) rendered by the virtual appliance as illustrated in FIGS. 5A-5B. Herein, each routing rule may be configured to (i) allow or deny the receipt of messages from a resource associated with a particular application domain and/or (ii) re-route messages sourced by a resource of a selected application domain or destined to a particular resource of another application domain, where the re-routing may be conducted to submit the messages to another resource (e.g., cyberthreat analyzer, firewall or an integrated firewall solution for multiple CSPs, etc.), to provide enhanced security for messages sent from or directed to the particular application domain. Additionally, each routing rule may include further parameters that restrict communications between application domains. For example, a routing rule may only allow or deny the transmission or receipt of messages associated with one or more selected transmission protocols (e.g., TCP, UDP, etc.) and/or associated with one or more selected port numbers (e.g., port number 443). The routing rule(s) associated with each application domain may be stored within a rule data store 257.

Referring still to FIG. 2, the policy configuration logic 260 is configured, in response to generation of a routing rule associated with an application domain, to conduct a translation of one or more tags used to identify resources within the application domain into IP addresses associated with those resources. The policy configuration logic 260 is configured to alter the routing rule by determining a tag for each resource included in the application domains associated with the routing rule, accessing the resource data store 270 determining an IP address associated with each tagged resource, substituting the IP address for its corresponding tag within the routing rule, and storing the altered routing rule within the rule data store 257. The altered routing rules are passed from the controller 160 into local storage associated with egress and/or ingress points of the cloud platform, such as spoke gateways 132/137/152/157 of FIG. 1A and/or transit gateways 164/169 of FIG. 1B.

### IV. Application Doman & Routing Rule Generation

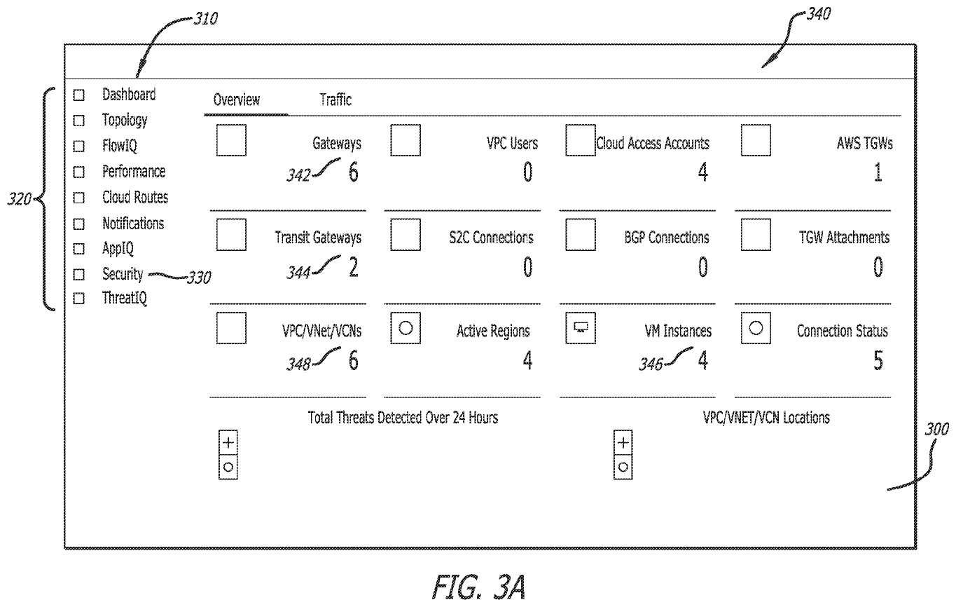

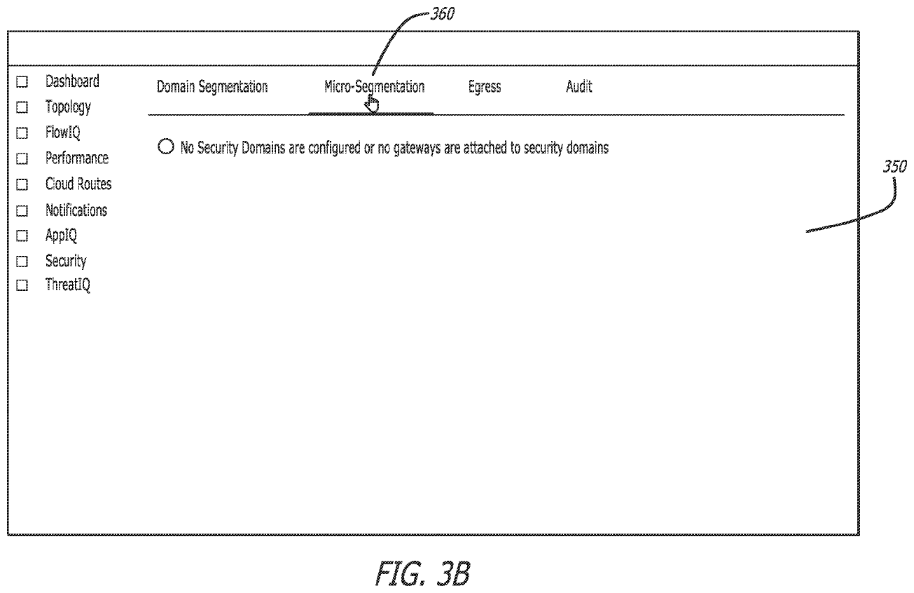

Referring now to FIG. 3A, an exemplary embodiment of a first display screen 300 rendered by a graphic user interface (GUI) of the virtual appliance 170 to control operability of the multi-cloud network 112 of FIGS. 1A-1B is shown. Herein, the first display screen 300 features a navigation menu 310 that includes a plurality of user interface (UI) display elements 320, including a security display element 330. Selection of the security display element 330 signals the virtual application 170 to generate a second display screen 350 as shown in FIG. 3B.

Besides the navigation menu 310, the first display screen 300 further includes a plurality of icons 340, which illustrate component types and operational features of the multi-cloud network 112 of FIGS. 1A-1B. For example, as shown in FIG. 3A, the plurality of icons 340 may include (i) a number of spoke gateways 342 representing entry points to the cloud platform, (ii) a number of transit gateways 344 that establish communications between different regions of a public cloud network or different public cloud networks, (iii) a number of VM instances 346 within the multi-cloud network 112, (iv) a number of VPCs 348 (VPC, VNets, VCNs) within the multi-cloud network 112 provided by different CSPs, or the like. These icons 340 are illustrated in a grid layout, although any orientation of the icons 340 may be used.

Referring now to FIG. 3B, an exemplary embodiment of the second screen display 350 rendered in response to selection of the security display element 330 of FIG. 3A for configuring micro-segmentation of the multi-cloud network 112 of FIGS. 1A-1B is shown. Herein, the second screen display 350 features a display element 360, positioned within a header 370 of the second screen display 350 for example, for configuring micro-segmentation of multi-cloud network 112 of FIGS. 1A-1B. When selected, the display element 360, labeled “Micro-Segmentation,” signals logic within the virtual appliance to generate a third display screen 400 that enables a tenant to create application domains as shown in FIGS. 4A-4D and/or routing policies represented by routing rules as shown in FIGS. 5A-5B.

Referring to FIG. 4A, an exemplary embodiment of the third display screen 400 rendered in response to selection of the Micro-Segmentation display element 360 of FIG. 3B is shown. Herein, the third display screen 400 includes a first display element 402 and a second display element 404. The first display element 402, when selected (automatically by default or by a tenant administrator), prompts the virtual appliance, operate in concert with the security logic 250 of the controller 160, to render a selectable display element for each previously created application domain (e.g., application domain display element 406). As an illustrative embodiment, the application domain display element 406 displays selected content, such as name 407, resource type 408 and rule reference 409 for example, to represent the application domain.

According to this illustrative embodiment, the name 407 identifies a label (“Current AD”) assigned to the application domain, while the resource type 408 includes the types of resources forming the application domain. For example, one resource type constitutes “VM” (virtual machines), which represent that the resources within the application domain correspond to VM instances. The rule reference 409 identifies the routing rules associated with the application domain. Although not shown, in response to selection of the application domain display element 406, an interactive display area may be generated that illustrates the resources associated with the application domain and allows for modification or deletion of the application domain.

As further shown in FIG. 4A, the third display screen 400 features a display element (Domain+) 410 that, when selected, prompts the generation of an interactive display area 420 within the third display screen 400 for use in creation of a new application domain as shown in FIG. 4B. The interactive display area 420 includes a plurality of interactive fields 425 that enables a tenant administrator to configure an application domain. For example, the plurality of interactive fields 425 may include a first input field 430, a second input field 431, a third input field 432, a fourth input field 433, a fifth input field 434, and/or a sixth input field 435. Some of these input fields, such as input fields 432-433, have constrained to the key value pairs associated with the discovered resources within the multi-cloud network 112 of FIGS. 1A-1B.

According to one embodiment of the disclosure, the first input field 430 may be configured as a text field, which allows a tenant administrator to enter a name chosen for the application domain. As shown, the application domain is chosen with the label “Web Applications.”

The second input field 431 may be configured as a resource selection type, which allows the tenant administrator to select different types of resources to be included as part of the application domain. For example, the resource type may be selected as “Virtual Machines” to denote that tags made available in input fields 432 and 433 correspond to resources that constitute VM instances within tenant's multi-cloud network. Alternatively, the resource type may be selected as “Virtual Subnet” or “VPC”, where the tags made available in input fields 432 and 433 correspond to virtual subnets or VPCs, respectively.

The input fields 432 and 433 constitute a key value pair (tag), where the second input field 432 corresponds to a key portion of the tag while the third input field 432 corresponds to a value portion of the tag. Herein, the third input field 432 is represented as a drop down menu, which allows for different key types to be selected. Each key type identifies a unique tag category, given that a plurality of tags associated with different category types may be assigned to a resource. For instance, a resource may be assigned a tag based on its label (name) as well as a tag that identifies a department (e.g., Sales, Accounting, Engineering, etc.) to which the resource pertains. As shown, the key types may include name, type, a logical region (e.g., department), and the like.

Based on the key type selected within the third input field 432, the fourth input field 433 identifies the values associated with the selected key type pertaining to the available resource tags. For example, as shown in FIG. 4C, in response to “name” being selected as the key type in the third input field 432, the fourth input field 433 operates as a drop down menu 440 that includes a listing of tag names 450 for each of the tagged resources discovered by the controller 160 and provided to the virtual appliance 170. Selection of one of the tags (e.g., “VM-Instance A”) is shown to identify that the application domain includes a VM instance resource tagged with the name “VM-Instance A”.

Referring back to FIG. 4B, the interactive display area 420 includes the fifth input field 434 that, when selected, allows for additional tags (i.e., key pairs) to be selected to further populate the application domain (Web Application) with additional tagged resources. In lieu of entry of the key value pair by relying on tags for populating the application domain, the sixth input field 435 allows for IP subnet address or CIDR may be entered. As shown in FIG. 4D, entry of the CIDR signals provides the controller with an application domain that is populated by all cloud components that resides within the identified IP subnet address or CIDR.

Referring to FIG. 5A, an exemplary embodiment of a fourth display screen 500 is shown in which the fourth display screen 500 is rendered upon selection of the second display element (Rules) 404 displayed within the third display screen 400 of FIG. 4A. Herein, the fourth display screen 500 features a display element (+Rule) 510 that, when selected, prompts the generation of an interactive display area 520 within the fourth display screen 500 for use in creating a routing rule. The interactive display area 520 includes a plurality of interactive fields 525 that enables a tenant administrator to configure a routing rule. For example, the plurality of interactive fields 525 may include, but are not limited to the following: a rule name input field 530; a source (application domain) input field 535; a destination (application domain) input field 540; an action input field 545; a protocol input field 550; a port number input field 555, an enforcement (activation) input field 560; and a logging input field 565.

According to this embodiment of the disclosure, the rule name input field 530 operates as a text field to allow for selection of a label to identify the routing rule. The name may be auto-generated or selected by the tenant administrator. The source input field 535 and destination input field 540 are auto-generated, pull-down menus that allow the tenant administrator to select application domains operating as a source and destination for a communication for which this routing rule applies. More specifically, the routing rule is applicable to both the application domain identified as the source and the application domain identified as the destination, and thus, the rule is applied to both of these application domains.

Additionally, the interactive display area 520 further includes the action input field 545, which may be set as to the operating state upon which the created routing rule is configured to allow certain types of transmissions, deny certain types of transmissions, or re-route certain types of transmissions originating from the source application domain and destined for the destination application domain. In the event that transmission re-routing is selected within the action input field 545, an additional field (not shown) may be generated to allow for selection of a targeted application domain or cloud components to receive the re-routed transmission.

The interactive display area 520 further features the protocol input field 550 and the port number input field 555. These input fields allows for selection of the type of protocol (e.g., TCP, UDP, etc.) and the port number(s) to further define the transmission type to be controlled (allowed, denied or re-routed). Based on these inputs, the routing rule may be tailored to transmissions associated with selected transmission protocol and/or port number(s).

The enforcement input field 560 is represented as a first toggle switch that, depending on the toggle switch position, signals whether the routing rule is active or inactive. Active routing rules, upon receipt of the policy configuration logic 260 and after conducting the tag-to-IP address mapping, are distributes to cloud components within the cloud platform to control traffic from resources within the “Web Applications” application domain and resources within the “App2” application domain. This selective enforcement of the routing rules provides greater control and flexibility to traffic distribution across the multi-cloud network. As a default, the routing rules may be placed into an inactive state, until activated by the tenant.

The logging input field 565 is represented as a second toggle switch that, depending on its position, signals whether the routing rules is placed into a logging or non-logging state. When placed into a logging state, logic within the virtual applications may be configured to gather information associated with message transmissions that are in compliance with and/or in violation of the routing rule. This logging may be conducted independent of whether the routing rule is active or inactive. This allows for a network administrator to test operational benefits associated with the application of each routing rule as well as determine their relevance. The degree of relevance may signify alteration or removal of the routing rule to reduce costs and/or workload.

Referring now to FIG. 5B, an exemplary embodiment of the fourth display screen 500 illustrating a routing rule 570 configured in accordance with the operations illustrated and described in FIG. 5A is shown. Herein, routing rule parameters are illustrated and consistent with the inputs selected as fields 530-565 shown in FIG. 5A. In particular, the listed routing rule 570 includes its name (allow_https) 530, the source application domain (Web Applications) 535, the destination application domain (App2) 540, the type of action undertaken (Allow) 545, the type of protocol (TCP) 550 applicable to the rule, and the port (port number 443) 555 associated with the routing rule. In addition, a first indication 560 identifies the enforcement status (Off-Disabled) of the routing rule 570, and a second indication 565 identifies a logging status with the routing rule (On-Enabled).

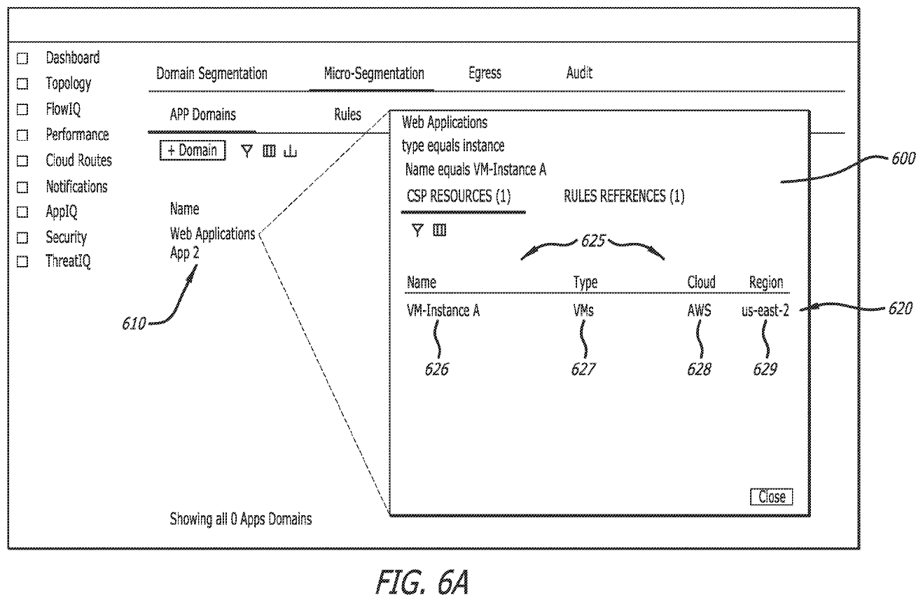

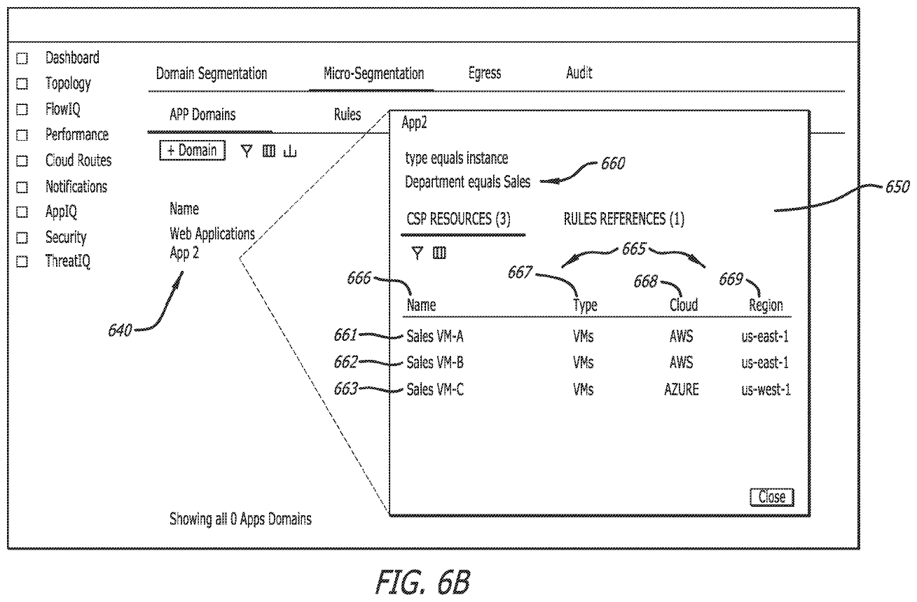

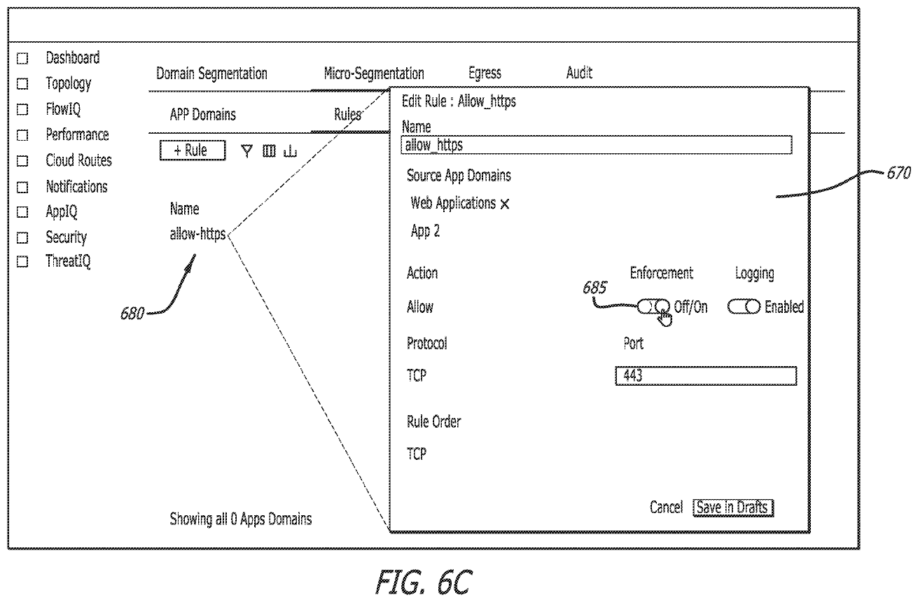

Referring to FIG. 6A, an exemplary embodiment of a first interactive display area 600 generated and displayed to illustrate resources of a first application domain 610 created upon conducting a set of operations illustrated in FIGS. 4A-4D is shown. Herein, upon selection of the first application domain 610 (Web Applications), the first interactive display area 600 is generated. The first interactive display area 600 lists a tag 622 associated with the one or more resources e.g., resource 620) included within the first application domain 610 along with characteristics 625 associated with resource 620. Examples of the characteristics 625 include, but are not limited or restricted to name 626, type 627 (identified as a VM instance), cloud service provider (CSP) 628, and region 629 in which the resource 620 resides.

Similarly, as shown in FIG. 6B, upon selection of a second application domain 640 (App 2), a second interactive display area 650 is generated that lists (i) a tag 660 associated with the resources 661-663 of the second application domain along with characteristics 665 of these resources 661-663. Examples of the characteristics 665 include, but are not limited or restricted to name 666, type 667 (identified as a VM instance), cloud service provider (CSP) 668, and region 629 in which the corresponding resource 661, 662, or 663 resides.

As shown in FIG. 6C, an exemplary embodiment of a third interactive display area 670 to illustrate a routing rule 680 controlling operability of the first and second application domains 610 and 640 is shown, where the routing rule 680 is configured in accordance with the operations illustrated in FIGS. 5A-5B. Herein, upon selection of the routing rule 680, the third interactive display area 670 is generated, which illustrates the input fields associated with the routing rule 680 (see FIG. 5A) that can be modified. For example, the routing rule 680 may be altered by adjusting a first toggle switch 685 that is associated with enforcement of the routing rule 680 from a disabled (off) state to an enabled (on) state. Similarly, the routing rule 680 may be altered by adjusting a second toggle switch 690 to change its logging operability. Additionally, the routing rule 680 could be renamed or different protocols or ports may be identified as well as the action of the rule whether it is to allow or disallow certain operability.

### V. Micro-Segmentation Layout

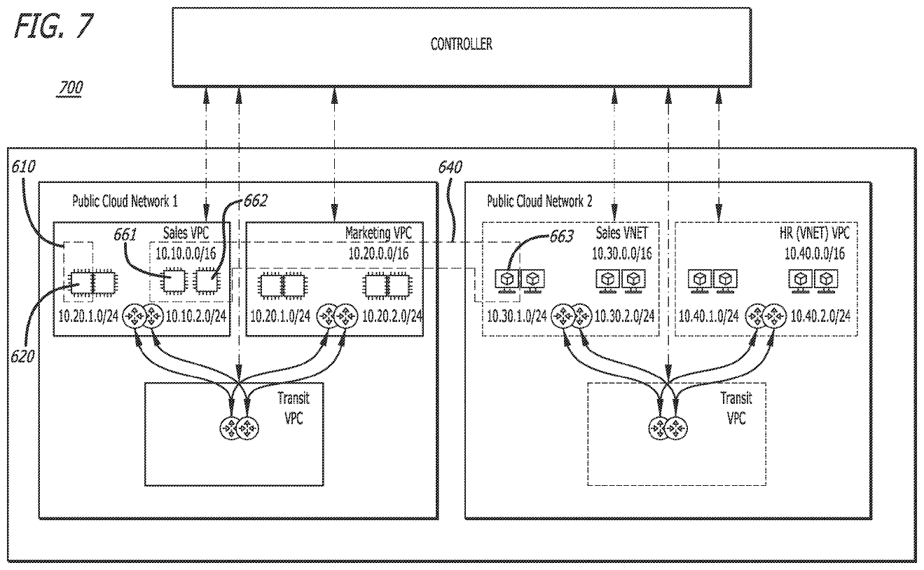

Referring now to FIG. 7, an exemplary embodiment of a layout of the first application domain 610 and the second application domain 640 illustrated in FIGS. 6A-6B is shown. Herein, the first application domain 610 includes the resource 620 constituting a first VM instance positioned within the first public cloud network 110. The second application domain 640 includes three resources, namely resource 661-663, where the first and second resource 661 and 662 constitute VM instances positioned within the first public cloud network 110. The third resource constitutes a VM instance positioned within the second public cloud network 115.

Embodiments of the invention may be embodied in other specific forms without departing from the spirit of the present disclosure. The described embodiments are to be considered in all respects only as illustrative, not restrictive.

What is claimed is:

1. A controller comprising:
a processor; and
a non-transitory storage medium communicatively coupled to the processor, the non-transitory storage medium includes (i) classification logic that, based on recovered information associated with a newly discovered endpoint, determines a virtual region in which the newly discovered endpoint resides, and (ii) rule generation logic configured to (a) generate a first subset of rules for controlling a flow of messages between a destination and a source via native cloud constructs associated with a cloud service provider (CSP) underlay network when the destination and source reside within a first virtual region and (b) generate a second subset of rules for controlling a flow of messages between the destination and the source via an overlay network providing communications between the first virtual region and a second virtual region when the destination and the source reside within different virtual regions, and use micro-segmentation to set and manage security policies.

2. The controller of claim 1, wherein the first virtual region corresponds to a first virtual private cloud network (VPC) and the second virtual region corresponds to a second VPC.

3. The controller of claims 2, wherein the first VPC resides within a first public cloud network and a second VPC resides within a second public cloud network different than the first public cloud network.

4. The controller of claim 2, wherein the second set of rules include filtering rules that formulate one or more policies that influence a propagation of inter-VPC network traffic over the overlay network establishing a communication path between the first VPC and the second VPC.

5. The controller of claim 4, wherein the first set of rules include filtering rules that formulate one or more policies that influence a propagation of intra-VPC network traffic over the underlay network.

6. The controller of claim 1, wherein the non-transitory storage medium further comprises endpoint discovery logic configured to identify newly added, modified, or deleted endpoints within one or more public cloud networks including the first virtual region and the second virtual region.

7. The controller of claim 6, wherein the recovered information associated with the newly discovered endpoint includes an identifier of the endpoint and an identifier of the virtual region.

8. The controller of claim 7, wherein the identifier of the virtual region includes a virtual private cloud network (VPC) identifier upon which the newly discovered endpoint resides.

9. The controller of claim 8, wherein the non-transitory storage medium further comprises logic to create and maintain an endpoint-to-VPC identifier mapping for use in determining whether or not security group orchestration is needed to support intra-VPC communications between the source and the destination.

10. The controller of claim 6, wherein the non-transitory storage medium further comprises security group generation logic configured to generate one or more network security groups, each network security group operating as a virtual firewall that is associated with an identified endpoint.

11. A method for controlling network traffic flow separation between inter-VPC communications and intra-VPC communications, comprising:
recovering information that identifies newly added, modified, or deleted endpoints within one or more public cloud networks;
based on recovered information associated with a newly discovered endpoint, determining a virtual region in which the newly discovered endpoint resides;
generating a first subset of rules for controlling a flow of messages sourced by or destined to the newly discovered endpoint via native cloud constructs associated with a cloud service provider (CSP) underlay network when the newly discovered endpoint and another endpoint in communication with and operating as a destination and a source of the flow of messages with the newly discovered endpoint reside within a first virtual region;
generating a second subset of rules for controlling a flow of messages sourced by or destined to the newly discovered endpoint via an overlay network providing communications between the first virtual region and a second virtual region when the newly discovered endpoint and another endpoint reside within different virtual regions; and
using micro-segmentation to set and manage security policies.

12. The method of claim 11, wherein the first virtual region corresponds to a first virtual private cloud network (VPC) and the second virtual region corresponds to a second VPC.

13. The method of claims 12, wherein the first VPC resides within a first public cloud network and a second VPC resides within a second public cloud network different than the first public cloud network.

14. The method of claim 12, wherein the second set of rules include filtering rules that formulate one or more policies that influence a propagation of inter-VPC network traffic over the overlay network establishing a communication path between the first VPC and the second VPC.

15. The method of claim 14, wherein the first set of rules include filtering rules that formulate one or more policies that influence a propagation of intra-VPC network traffic over the underlay network.

16. The method of claim 11, wherein the recovered information associated with the newly discovered endpoint includes an identifier of the endpoint and an identifier of the first virtual region.

17. The method of claim 11 further comprising:
creating and maintaining an endpoint-to-VPC identifier mapping for use in determining whether or not security group orchestration is needed to support intra-VPC communications between the newly discovered endpoint and another endpoint.

18. A non-transitory storage medium including logic that, upon execution, controls flow separation for inter-VPC communications and intra-VPC communications, comprising:
endpoint discovery logic configured to identify newly added, modified, or deleted endpoints within a plurality of public cloud networks;
classification logic configured, based on recovered information associated with a newly discovered endpoint, to determine a virtual region in which the newly discovered endpoint resides; and
rule generation logic configured to (i) generate a first subset of rules for controlling a flow of messages between a destination and a source via native cloud constructs associated with a cloud service provider (CSP) underlay network when the destination and source reside within a first virtual region and (ii) generate a second subset of rules for controlling a flow of messages between the destination and the source via an overlay network providing communications between the first virtual region and a second virtual region when the destination and the source reside within different virtual regions, and use micro-segmentation to set and manage security policies.

19. The non-transitory storage medium of claim 18, wherein the second subset of rules includes a rule that controls and filter the messages over the overlay network when the source resides in the first virtual region included in the first public cloud network and the destination resides in the second virtual region included in the second public cloud network, to be enforced by native cloud constructs to propagate messages perform intra-VPC network traffic controls for messaging between and a second subset of rules to be enforced by one or more spoke gateways to perform inter-VPC network traffic controls.

20. The non-transitory storage medium of claim 18, wherein the non-transitory storage medium communicatively coupled to the processor, the non-transitory storage medium includes endpoint discovery logic, classification logic, security group generation logic, and rule generation logic.
